(19) United States
(12) Patent Application Publication
(10) Pub. No.: US 2026/0297991 A1
(43) Pub. Date: Oct. 1, 2026

(54) Lock Assemblies And System For Roll-Up Door

(71) Applicant: Morgan Olson LLC, Sturgis, MI (US)

(72) Inventor: Per-Erik Appelo, Knoxville, TN (US)

(21) Appl. No.: 19/634,620

(22) Filed: Mar. 31, 2026

Related U.S. Application Data
(60) Provisional application No. 63/780,998, filed on Mar. 31, 2025.

(51) Int. Cl. E05B 83/04; E05B 81/08

(52) U.S. Cl. CPC E05B 83/04; E05B 81/08

(57) ABSTRACT

A lock system for securing a roll-up door in a closed position is disclosed. The lock system includes a main latch assembly having a main latch body that is movable about and between a locked position and an unlocked position. A secondary latch assembly is movable about and between a secured configuration and a released configuration. In the secured configuration, the secondary latch assembly inhibits movement of the main latch body from the locked position to the unlocked position, and in the released configuration, the secondary latch assembly permits movement of the main latch body from the locked position to the unlocked position. The secondary latch assembly is configured so that when the roll-up door is in the closed position, the secondary latch assembly is inhibited from moving to the released configuration.

### CROSS-REFERENCE TO RELATED APPLICATION

This application claims priority to, and the benefit of the filing date of, U.S. Provisional Patent Application No. 63/780,998, filed Mar. 31, 2025, the entirety of which is incorporated by reference herein.

### FIELD

This application relates to lock assemblies systems for roll-up doors, such as, for example, keyless lock systems for roll-up doors of parcel walk-in vans and other vehicles.

### BACKGROUND

Roll-up doors are used in various applications, from storage to transportation applications. For example, parcel walk-in vans typically have a roll-up door in the back of the vehicle with access to the cargo area. Theft of high value cargo from parcel vehicles is presently attracting increasing levels of attention. Current keyless lock designs are either susceptible to break-in attempts, wherein the main latch can be forced to unlatch, or, alternatively, require complicated and expensive servo-operated latches. Servo-actuated latches are either required to be unlocked to allow the door to close or, alternatively, require a secondary latch that, in turn, can be forced open during a theft attempt. Accordingly, a solution that inhibits break-in attempts is desirable.

### SUMMARY

Disclosed herein is a lock system for securing a roll-up door in a closed position. The lock system comprises a main latch assembly comprising a main latch body that is movable about and between a locked position and an unlocked position. A secondary latch assembly is movable about and between a secured configuration and a released configuration. In the secured configuration, the secondary latch assembly inhibits movement of the main latch body from the locked position to the unlocked position. In the released configuration, the secondary latch assembly permits movement of the main latch body from the locked position to the unlocked position. The secondary latch assembly is configured so that when the roll-up door is in the closed position, the secondary latch is inhibited from moving to the released configuration.

Also disclosed herein is a door system comprising a roll-up door, the roll-up door comprising at least one panel, a wheel, and an axle that couples the at least one panel to the wheel. The door system further comprises a track defining a channel that receives the at least one wheel and permits movement of the wheel along the track. The door system further comprises a lock system as disclosed herein. The main latch body of the lock system projects into the channel when in the locked position. Contact between the secondary latch assembly and the roll-up door inhibits movement of the secondary latch assembly to the released configuration.

### BRIEF DESCRIPTION OF THE DRAWINGS

The accompanying drawings, which are incorporated in and constitute a part of this specification, illustrate several embodiments of the disclosed apparatus, system, and method and together with the description, serve to explain the principles of the disclosed apparatus, system, and method.

FIG. 1 is a front view of a lock system having a main latch body in a locked position and a secondary latch assembly in a secured configuration.

FIG. 2 is a front view of the lock system of FIG. 1, in which the main latch body is in an unlocked position and a secondary latch assembly in a released configuration.

FIG. 3 is an exploded view of the lock system of FIG. 1.

FIG. 4 is a perspective view of the lock system of FIG. 1.

FIG. 5 is a front view of another lock system having a main latch body in a locked position and a secondary latch assembly in a secured configuration.

FIG. 6 is a front view of another lock system having a main latch body in a locked position and a secondary latch assembly in a secured configuration.

FIG. 7 is a front view of the lock system of FIG. 6, in which the main latch body is in an unlocked position and a secondary latch assembly in a released configuration.

FIG. 8 is a schematic rear view of a vehicle including a lock system as disclosed herein, the lock system including a roll up door that is in a partially open position.

### DETAILED DESCRIPTION

The disclosed system and method may be understood more readily by reference to the following detailed description of particular embodiments and the examples included therein and to the Figures and their previous and following description.

It is to be understood that the terminology used herein is for the purpose of describing particular embodiments only and is not intended to limit the scope of the present invention which will be limited only by the appended claims.

It must be noted that as used herein and in the appended claims, the singular forms “a,” “an,” and “the” can include plural references unless the context clearly dictates otherwise. Thus, for example, reference to “a wheel” amounts to a disclosure of embodiments in which only a wheel is provided, as well as embodiments in which a plurality of such wheels are provided.

“Optional” or “optionally” means that the subsequently described event, circumstance, or material may or may not occur or be present, and that the description includes instances where the event, circumstance, or material occurs or is present and instances where it does not occur or is not present.

Ranges may be expressed herein as from “about” one particular value, and/or to “about” another particular value. When such a range is expressed, also specifically contemplated and considered disclosed is the range from the one particular value and/or to the other particular value unless the context specifically indicates otherwise. Similarly, when values are expressed as approximations, by use of the antecedent “about,” it will be understood that the particular value forms another, specifically contemplated embodiment that should be considered disclosed unless the context specifically indicates otherwise. It will be further understood that the endpoints of each of the ranges are significant both in relation to the other endpoint, and independently of the other endpoint unless the context specifically indicates otherwise. Finally, it should be understood that all of the individual values and sub-ranges of values contained within an explicitly disclosed range are also specifically contemplated and should be considered disclosed unless the context specifically indicates otherwise. The foregoing applies regardless of whether in particular cases some or all of these embodiments are explicitly disclosed.

Optionally, in some aspects, when values or characteristics are approximated by use of the antecedents “about,” “substantially,” or “generally,” it is contemplated that values within up to 15%, up to 10%, up to 5%, or up to 1% (above or below) of the particularly stated value or characteristic can be included within the scope of those aspects.

Unless defined otherwise, all technical and scientific terms used herein have the same meanings as commonly understood by one of skill in the art to which the disclosed apparatus, system, and method belong. Although any apparatus, systems, and methods and materials similar or equivalent to those described herein can be used in the practice or testing of the present apparatus, system, and method, the particularly useful methods, devices, systems, and materials are as described.

Throughout the description and claims of this specification, the word “comprise” and variations of the word, such as “comprising” and “comprises,” means “including but not limited to,” and is not intended to exclude, for example, other additives, components, integers or steps.

In particular, in methods stated as comprising one or more steps or operations it is specifically contemplated that each step comprises what is listed (unless that step includes a limiting term such as “consisting of”), meaning that each step is not intended to exclude, for example, other additives, components, integers or steps that are not listed in the step.

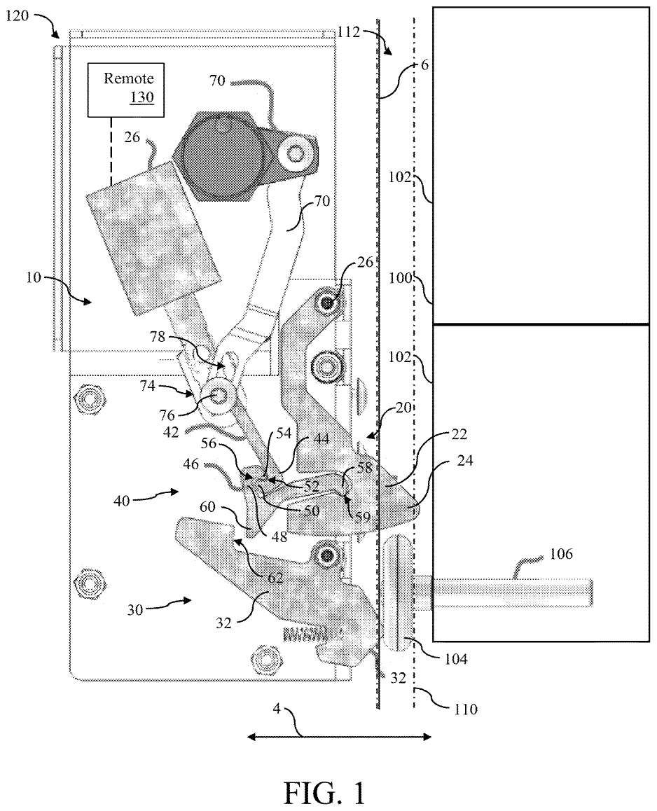

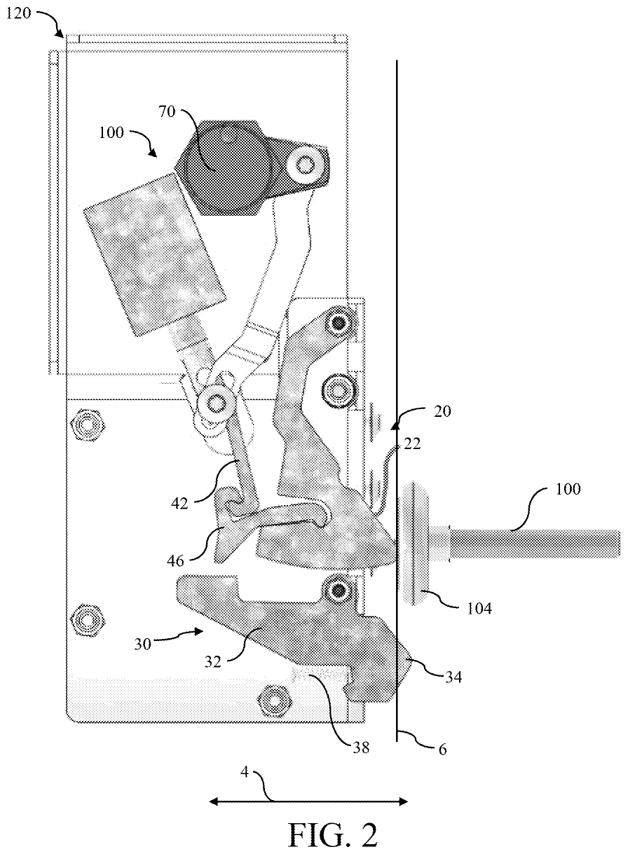

Referring now to FIGS. 1-2, a lock system 10 for securing a roll-up door 100 in a closed position is shown. The lock system 10 can comprise a main latch assembly 20 having a main latch body 22 that is movable about and between a locked position (FIG. 1) and an unlocked position (FIG. 2). A secondary latch assembly 30 can be movable about and between a secured configuration (FIG. 1) and a released configuration (FIG. 2). In the secured configuration, the secondary latch assembly 30 can inhibit movement of the main latch body 22 from the locked position to the unlocked position, and in the released configuration, the secondary latch assembly 30 can permit movement of the main latch body 22 from the locked position to the unlocked position. The secondary latch assembly 30 can be configured so that when the roll-up door 100 is in the closed position, the secondary latch assembly 30 is inhibited from moving to the released configuration. Accordingly, when the roll-up door 100 is closed and latched, the roll-up door can inhibit movement of the second latch assembly 30 to the released configuration, and the second latch assembly can, in turn, inhibit movement of the main latch body 22 to the unlocked position. In this way, the roll-up door 100, by being in the closed position, can cooperate with the lock system 10 to inhibit movement of the main latch body 22 to an unlocked position in a break-in attempt.

In some aspects, a portion 24 of the main latch body 22 can be movable along a horizontal axis 4 to extend beyond a plane 6 perpendicular to the horizontal axis 4 as the main latch body 22 is moved from the locked position to the unlocked position. The portion 24 of the main latch body 22 that extends beyond the plane 6 can be positioned within a path of travel of the roll-up door, thereby inhibiting movement of the door from a closed position. For example, in some aspects, the roll-up door 100 can comprise at least one panel 102 (optionally, a plurality of panels), at a wheel 104, and an axle 106 that couples the at least one panel 102 to the wheel 104. The wheel 104 can be movable within a track 110. When the roll-up door 100 is closed and the main latch body 22 is in the locked position, the portion 24 of the main latch body 22 can overhang the wheel 104, thereby inhibiting movement of the roll-up door 100 from the closed position. In other aspects, the roll-up door 100 does not have wheels. For example, the sides of the door 100 can slide within tracks (e.g., channels). Optionally, in these aspects, a side of the roll-up door 100 can engage the lock system 10. For example, the portion 24 of the main latch body 22 can be received within a notch defined within the side of the door.

The main latch assembly 20 can comprise a solenoid 26 that is coupled to the main latch body 22. The solenoid 26 can be operable to move the main latch body 22 about and between the locked position and the unlocked position.

The solenoid 26 can be coupled to the main latch body 22 by a main latch linkage 40. That is, movement of the solenoid 26 can move the main latch linkage 40, thereby actuating the main latch body 22. In some aspects, the secondary latch assembly 30 can engage the main latch linkage 40 to inhibit movement of the main latch body 22 from the locked position to the unlocked position.

For example, in some aspects, and with reference to FIG. 1, the main latch linkage 40 can comprise a first member 42 that is coupled to the solenoid 26. The first member 42 can comprise a hook 44. The main latch linkage 40 can further comprise a second member 46 comprising a first hook 48 that engages the hook 44 of the first member 42. For example, the hook 44 of the first member 42 can have a distal end 50 and can define a recess 52. The first hook 48 of the second member 46 can have a distal end 54 and can define a recess 56. The distal end 50 of the hook 44 can be received within the recess 56 of the first hook 48, and the distal end 54 of the first hook 48 can be received within the recess 52 of the hook 44. The first hook 48 of the second member 46 can pivot within the hook 44 of the first member 42. The first and second members 42, 46 can further be contained within a housing, as further disclosed herein, to inhibit separation from each other. In this way, the first and second members 42, 46 can be pivotably engaged. The second member 46 can further comprise a second hook 58 that is receivable into a slot 59 of the main latch body 22 so that the second hook 58 remains retained within the slot 59, while allowing pivotal movement between the second member 46 and the main latch body 22.

The second member 46 can comprise projection 60 that is positioned between the main latch body 22 and the secondary latch assembly 30 so that when the main latch body 22 is in the locked position and the secondary latch assembly is in the secured configuration, movement of the main latch body 22 toward the unlocked position drives the second member 46 against the secondary latch assembly 30, thereby inhibiting movement of the main latch body to the unlocked position. For example, the secondary latch assembly 30 can define a groove 62 that receives the projection 60 therein.

In some aspects, the main latch 20 can comprise a manual lock 70, such as, for example, a conventional tumbler lock. The manual lock 70 can be movable about and between a locked configuration and an unlocked configuration. The manual lock 70 can be coupled to the main latch assembly 20 to permit movement of the main latch body 22 from the locked position to the unlocked position independently of a position of the solenoid 26. For example, the manual lock 70 can comprise an arm 72 that couples the manual lock 70 to the main latch linkage 40.

The main latch linkage 40 can comprise a pivotal coupling 74 between the solenoid 26 and the first member 42, the pivotal coupling 74 having a pivotal axis 76. The arm 72 can define a slot 78 that surrounds the pivotal axis 76 of the pivotal coupling 74. Movement of the manual lock 70 from the locked configuration to the unlocked configuration can move the arm 72, thereby changing the position of the slot 78. When the slot 78 is in a first position relative to the pivotal axis 76, the main latch body 22 can pivot independently of the position of the solenoid 26.

In some aspects, the main latch body 22 can be pivotable about an axis 26 to move between the locked position and the unlocked position. In other aspects, the main latch body 22 can be axially slidable to move between the locked position and the unlocked position.

In some aspects, a portion 34 of the secondary latch assembly 30 can extend beyond the plane 6 when the roll-up door 100 is not in the closed position. The secondary latch assembly 30 can be biased toward the released configuration. For example, the secondary latch assembly 30 can comprise a secondary latch body 32. The secondary latch assembly 30 can comprise a spring 38 that biases the secondary latch body 32 across the plane 6. In some aspects, the portion 24 of the main latch body 22 can be positioned vertically above said portion 34 of the secondary latch assembly 30.

The secondary latch body 32 can bias laterally against the roll-up door 100 (e.g., the wheel 104) to move the secondary latch assembly 30 to the secured configuration. Accordingly, as can be seen in FIG. 1, any attempt to force the main latch body 22 out of the way of the door drives the main latch linkage 40 (e.g., the second member 46) into engagement with the secondary latch assembly 30.

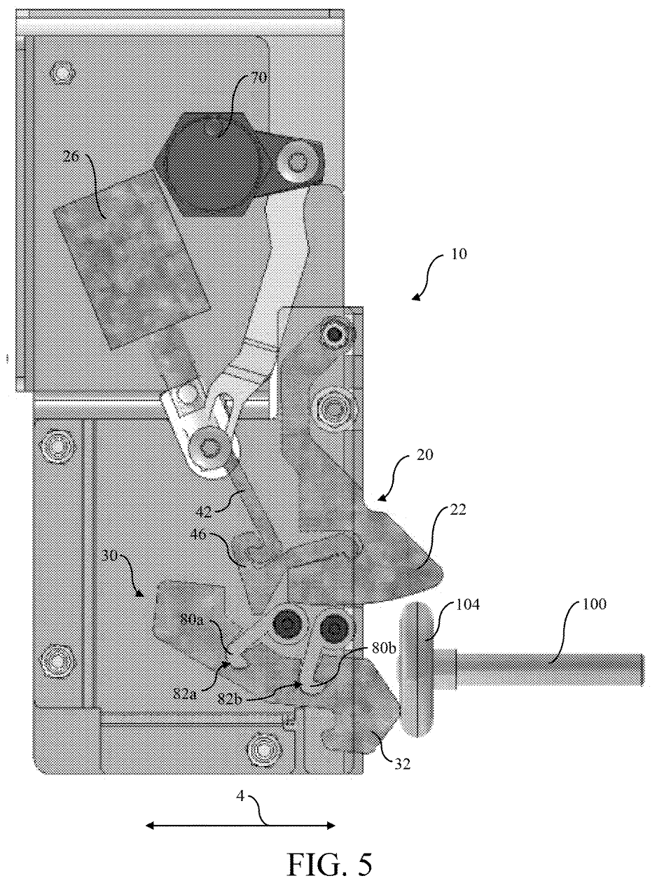

In some aspects, and as shown in FIG. 1, the secondary latch body 32 can be pivotable about a pivotal axis 76. In additional aspects, and with reference to FIG. 5, the secondary latch body 32 can be configured to pivot and slide laterally (translate). For example, the secondary latch assembly 30 can further comprise a first hook 80a that is receivable into a first slot 82a of the secondary latch body 32, and a second hook 80b that is receivable into a second slot 82b of the secondary latch body 32. Each of the first and second hooks 80a, b can each pivot about a respective axis. The first and second hooks 80a, b can permit movement of the secondary latch body 32 along a path that includes rotation and translation of the secondary latch body 32.

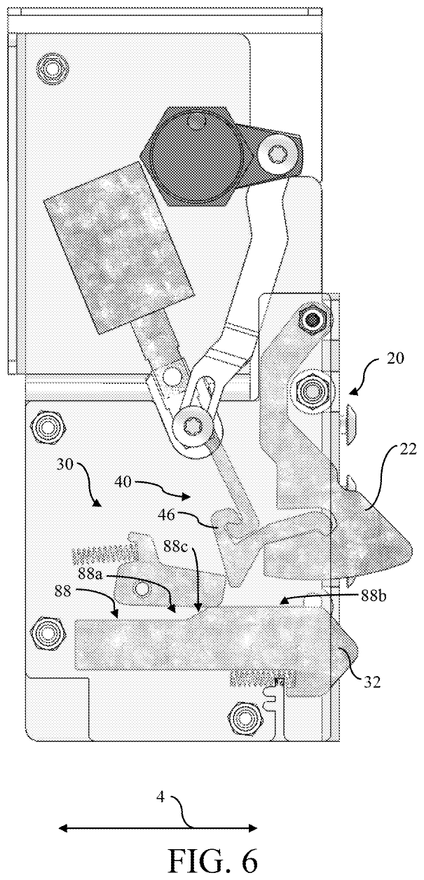

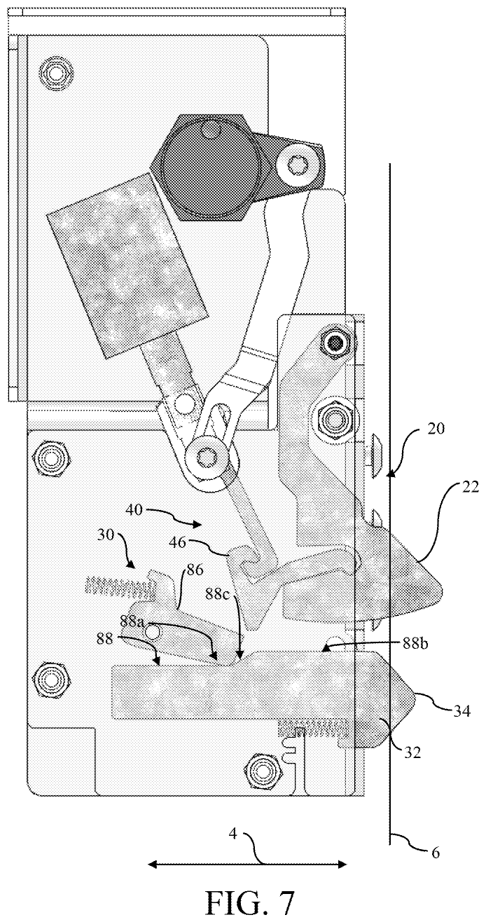

Referring to FIG. 6, and 7, in additional aspects, at least a portion of the secondary latch assembly 30 can be slidable along the horizontal axis 4. For example, the secondary latch assembly 30 can comprise a secondary latch body 32 that is slidable along the horizontal axis 4. The secondary latch assembly 30 can comprise a stop element 86 that is configured to bias against the main latch linkage 40 (e.g., the second member 46) during an attempted breach, when the secondary latch assembly 30 is in the secured configuration. The stop element 86 can be spring-biased away from a secured position (FIG. 6) that engages the main latch linkage 40 in an attempted breach. The secondary latch body 32 can have a surface 88 that slides against the stop element 86. The surface 88 can comprise a first portion 88a that engages the stop element 86 when the secondary latch assembly 30 is in the released configuration (FIG. 7), in which the roll-up door 100 is moved from the closed position so that the portion 34 of the secondary latch body 32, under a spring bias, projects beyond the plane 6. The first portion 88a of the surface can be recessed to permit the stop element 86 to move away from the secured position. The surface 88 can further comprise a second portion 88b that engages the stop element 86 when the roll-up door engages the secondary latch body 32. The surface 88 can further comprise a ramped portion 88 c between the first and second portions 88a, b. Accordingly, when the roll-up door 100 engages the secondary latch body 32, the secondary latch body 32 can be urged axially along the horizontal axis 4. The stop element 86, sliding along the surface 88, can move from contact with the first portion to the second portion, thereby pivoting the stop element 86 into the secured position (FIG. 7).

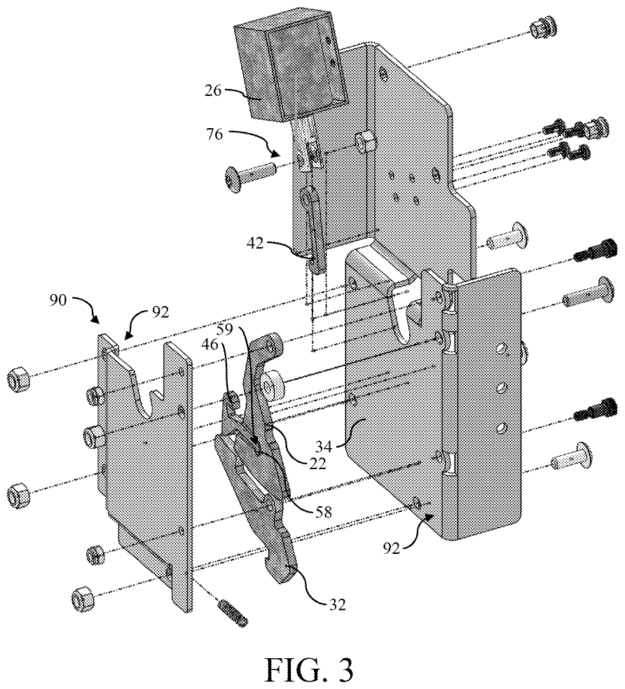

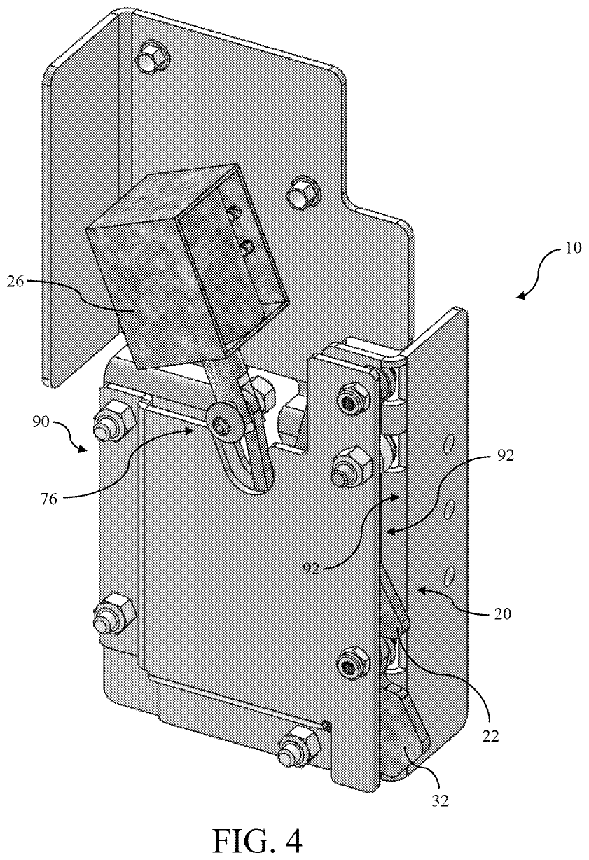

Referring to FIG. 3, the lock system 10 can comprise a housing 90 having laterally spaced opposed walls 92 between which various elements of the lock system 10, such as the first and second members 42, 46, the main latch body 22, and the secondary latch body 32 are received to retain said elements in engagement with each other. For example, the second hook 58 of the second member 46 can be receivable into the slot 59 of the main latch body 22 when the second member 46 and the main latch body 22 are moved relative to each other along an axis perpendicular to the page in FIG. 1. Once the housing 90 is assembled (FIG. 4), movement of the second member 46 and the main latch body along said axis is restricted, thereby maintaining engagement therebetween. In a similar fashion, the housing 90 can retain various other elements in connection with each other while permitting movement of said elements in the plane of the page in FIGS. 1, 2, and 5-7.

A door system 120 can comprise a roll-up door 100 and a track 110 defining a channel 112 within which at least a portion of the roll-up door 100 is movable. For example, the roll-up door 100 can comprise a wheel 104 that moves within the track 110. The door system 120 can further comprise a lock system 10. The main latch body 22 can project into the channel 112 when in the locked position. Contact between the secondary latch assembly 30 and the roll-up door 100 can inhibit movement of the secondary latch assembly to the released configuration.

The main latch assembly 20 can comprise a solenoid 26 that is coupled to the main latch body 22. The door system 120 can further comprise a remote 130 that is configured to communicate wirelessly with the solenoid 26 to cause the solenoid 26 to move the main latch body about and between the locked position and the unlocked position.

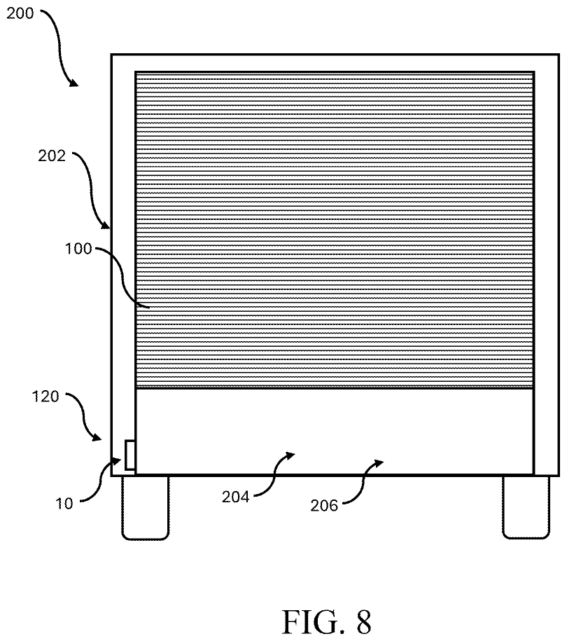

The disclosed lock system 10 and door system 120 can be provided on a vehicle, such as a walk-in van, a delivery truck, or the like. For example, FIG. 8 illustrates a vehicle 200 having a door system 120 including the roll-up door 100 and the lock system 10. The roll-up door 100 can be, for example, a rear door or a side door. In various aspects, the vehicle 200 can be a walk-in van or a truck, such as, for example, a delivery truck. In exemplary aspects, the vehicle 200 can be a box truck, a trailer, or a step van. For example, the vehicle 200 can comprise a rear enclosure 202 defining a cargo area 204 and an opening 206. The roll-up door 100 of the door system 120 can be configured to selectively cover the opening 206. In some aspects, the vehicle 200 can further comprise a cab. In some aspects, the cab can be separated from the rear enclosure. In additional aspects, the cab and the rear enclosure can be separated by a bulkhead. The bulkhead can optionally have an access door that provides access between the cab and the rear enclosure. In other aspects, the cab and cargo area can be unpartitioned. In additional aspects, the roll-up door 100 and the lock system 10 can be provided on a structure, such as a storage unit or a garage.

Those skilled in the art will recognize, or be able to ascertain using no more than routine experimentation, many equivalents to the specific embodiments of the method and compositions described herein. Such equivalents are intended to be encompassed by the following claims.

### Exemplary Aspects

In view of the described apparatus and methods, below are certain more particularly described aspects of the invention. These particularly recited aspects should not however be interpreted to have any limiting effect on any different claims containing different or more general teachings described herein, or that the “particular” aspects are somehow limited in some way other than the inherent meanings of the language literally used therein.

Aspect 1: A lock system for securing a roll-up door in a closed position, the lock system comprising: a main latch assembly comprising a main latch body that is movable about and between a locked position and an unlocked position; and a secondary latch assembly that is movable about and between a secured configuration and a released configuration, wherein: in the secured configuration, the secondary latch assembly inhibits movement of the main latch body from the locked position to the unlocked position, and in the released configuration, the secondary latch assembly permits movement of the main latch body from the locked position to the unlocked position, wherein the secondary latch assembly is configured so that when the roll-up door is in the closed position, the secondary latch is inhibited from moving to the released configuration.

Aspect 2: A lock system according to any aspect described herein, particularly aspect 1, wherein a portion of the main latch body is movable along a horizontal axis to extend beyond a plane perpendicular to the horizontal axis as the main latch body is moved from the locked position to the unlocked position, wherein the portion of the main latch body that extends beyond the plane is positioned within a path of travel of the roll-up door.

Aspect 3: A lock system according to any aspect described herein, particularly aspect 2, wherein a portion of the secondary latch assembly extends beyond the plane when the roll-up door is not in the closed position.

Aspect 4: A lock system according to any aspect described herein, particularly aspect 3, wherein the portion of the main latch body is positioned vertically above the portion of the secondary latch assembly.

Aspect 5: A lock system according to any aspect described herein, particularly aspect 1, wherein the main latch assembly further comprises a solenoid that is coupled to the main latch body, wherein the solenoid is operable to move the main latch body about and between the locked position and the unlocked position.

Aspect 6: A lock system according to any aspect described herein, particularly aspect 5, wherein the main latch assembly further comprises a manual lock, wherein the manual lock is movable about and between a locked configuration and an unlocked configuration, wherein the manual lock is coupled to the main latch assembly to permit movement of the main latch body from the locked position to the unlocked position independently of a position of the solenoid.

Aspect 7: A lock system according to any aspect described herein, particularly aspect 6, wherein the main latch assembly further comprises a main latch linkage that couples the main latch body to the solenoid.

Aspect 8: A lock system according to any aspect described herein, particularly aspect 7, wherein main latch assembly further comprises an arm that couples the manual lock to the main latch linkage.

Aspect 9: A lock system according to any aspect described herein, particularly aspect 8, wherein the main latch linkage comprises a pivotal coupling, wherein the arm defines a slot that surrounds the pivotal coupling.

Aspect 10: A lock system according to any aspect described herein, particularly aspect 7, wherein the main latch linkage comprises: a first member that pivotally couples to the solenoid, wherein the first member comprises a hook; a second member comprising a hook that engages the hook of the first member and a projection that is positioned between the main latch body and the secondary latch assembly so that when the secondary latch assembly is in the secured configuration, movement of the main latch body toward the unlocked position drives the second member against the secondary latch assembly, thereby inhibiting movement of the main latch body to the unlocked position.

Aspect 11: A lock system according to any aspect described herein, particularly aspects 1-9, wherein the main latch body is pivotable about and between the locked position and unlocked position.

Aspect 12: A lock system according to any aspect described herein, particularly aspect 3, wherein the secondary latch assembly comprises a secondary latch body that comprises the portion of the secondary latch assembly that extends beyond the plane when the roll-up door is not in the closed position.

Aspect 13: A lock system according to any aspect described herein, particularly aspect 12, wherein the secondary latch body is spring-biased toward a position in which the portion of the secondary latch assembly extends beyond the plane.

Aspect 14: A lock system according to any aspect described herein, particularly aspect 12, wherein the secondary latch body is pivotal about a pivotal axis.

Aspect 15: A lock system according to any aspect described herein, particularly aspect 12, wherein the secondary latch body is slidable along the horizontal axis.

Aspect 16: A door system comprising: a roll-up door comprising: at least one panel; a wheel; and an axle that couples the at least one panel to the wheel; a track defining a channel that receives the wheel and permits movement of the wheel along the track; and the lock system according to any aspect described herein, particularly aspect 1, wherein: the main latch body projects into the channel when in the locked position, and contact between the secondary latch assembly and the roll-up door inhibits movement of the secondary latch assembly to the released configuration.

Aspect 17: A door system according to any aspect described herein, particularly aspect 16, wherein the main latch assembly comprises a solenoid that is coupled to the main latch body, wherein the solenoid is operable to move the main latch body about and between the locked position and the unlocked position, wherein the door system further comprises a remote configured to communicate wirelessly with the solenoid to cause the solenoid to move the main latch body about and between the locked position and the unlocked position.

Aspect 18: A vehicle comprising:
a rear enclosure defining a cargo area and an opening;
a door system as in claim 16, wherein the roll-up door is configured to selectively cover the opening of the rear enclosure.

Aspect 19: The vehicle of aspect 18, wherein the vehicle is a delivery truck or a walk-in van.

Aspect 20: The vehicle of aspect 18, wherein the opening is positioned on a rear end of the vehicle.

Aspect 21: The vehicle of aspect 18, wherein the opening is positioned on a side of the vehicle.

Those skilled in the art will recognize, or be able to ascertain using no more than routine experimentation, many equivalents to the specific embodiments of the apparatus and methods described herein. Such equivalents are intended to be encompassed by the following claims.

1. A lock system for securing a roll-up door in a closed position, the lock system comprising:
a main latch assembly comprising a main latch body that is movable about and between a locked position and an unlocked position; and
a secondary latch assembly that is movable about and between a secured configuration and a released configuration, wherein:
in the secured configuration, the secondary latch assembly inhibits movement of the main latch body from the locked position to the unlocked position, and
in the released configuration, the secondary latch assembly permits movement of the main latch body from the locked position to the unlocked position,
wherein the secondary latch assembly is configured so that when the roll-up door is in the closed position, the secondary latch is inhibited from moving to the released configuration.

2. The lock system of claim 1, wherein a portion of the main latch body is movable along a horizontal axis to extend beyond a plane perpendicular to the horizontal axis as the main latch body is moved from the locked position to the unlocked position, wherein the portion of the main latch body that extends beyond the plane is positioned within a path of travel of the roll-up door.

3. The lock system of claim 2, wherein a portion of the secondary latch assembly extends beyond the plane when the roll-up door is not in the closed position.

4. The lock system of claim 3, wherein the portion of the main latch body is positioned vertically above the portion of the secondary latch assembly.

5. The lock system of claim 1, wherein the main latch assembly further comprises a solenoid that is coupled to the main latch body, wherein the solenoid is operable to move the main latch body about and between the locked position and the unlocked position.

6. The lock system of claim 5, wherein the main latch assembly further comprises a manual lock, wherein the manual lock is movable about and between a locked configuration and an unlocked configuration, wherein the manual lock is coupled to the main latch assembly to permit movement of the main latch body from the locked position to the unlocked position independently of a position of the solenoid.

7. The lock system of claim 6, wherein the main latch assembly further comprises a main latch linkage that couples the main latch body to the solenoid.

8. The lock system of claim 7, wherein main latch assembly further comprises an arm that couples the manual lock to the main latch linkage.

9. The lock system of claim 8, wherein the main latch linkage comprises a pivotal coupling, wherein the arm defines a slot that surrounds the pivotal coupling.

10. The lock system of claim 7, wherein the main latch linkage comprises:
a first member that pivotally couples to the solenoid, wherein the first member comprises a hook;
a second member comprising a hook that engages the hook of the first member and a projection that is positioned between the main latch body and the secondary latch assembly so that when the secondary latch assembly is in the secured configuration, movement of the main latch body toward the unlocked position drives the second member against the secondary latch assembly, thereby inhibiting movement of the main latch body to the unlocked position.

11. The lock system of claim 1, wherein the main latch body is pivotable about and between the locked position and the unlocked position.

12. The lock system of claim 3, wherein the secondary latch assembly comprises a secondary latch body that comprises the portion of the secondary latch assembly that extends beyond the plane when the roll-up door is not in the closed position.

13. The lock system of claim 12, wherein the secondary latch body is spring-biased toward a position in which the portion of the secondary latch assembly extends beyond the plane.

14. The lock system of claim 12, wherein the secondary latch body is pivotal about a pivotal axis.

15. The lock system of claim 12, wherein the secondary latch body is slidable along the horizontal axis.

16. A door system comprising:
a roll-up door comprising:
at least one panel;
a wheel; and
an axle that couples the at least one panel to the wheel;
a track defining a channel that receives the wheel and permits movement of the wheel along the track; and
the lock system of claim 1, wherein:
the main latch body projects into the channel when in the locked position, and
contact between the secondary latch assembly and the roll-up door inhibits movement of the secondary latch assembly to the released configuration.

17. The door system of claim 16, wherein the main latch assembly comprises a solenoid that is coupled to the main latch body, wherein the solenoid is operable to move the main latch body about and between the locked position and the unlocked position, wherein the door system further comprises a remote configured to communicate wirelessly with the solenoid to cause the solenoid to move the main latch body about and between the locked position and the unlocked position.

18. A vehicle comprising:
a rear enclosure defining a cargo area and an opening;
a door system as in claim 16, wherein the roll-up door is configured to selectively cover the opening of the rear enclosure.

19. The vehicle of claim 18, wherein the vehicle is a delivery truck or a walk-in van.

20. The vehicle of claim 18, wherein the opening is positioned on a rear end of the vehicle.
